(19) United States
(12) Patent Application Publication
(10) Pub. No.: US 2006/0097825 A1
(43) Pub. Date: May 11, 2006

(54) Dielectric resonator and communication apparatus using the same

(76) Inventors: Toru Kurisu, Shiga-Ken (JP); Kazuhiko Kubota, Kyoto-fu (JP); Hirotsugu Abe, Shiga-ken (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/532,222

(22) PCT Filed: Oct. 27, 2004
(86) PCT No.: PCT/JP04/15901

§ 371 Date: Apr. 22, 2005

(30) Foreign Application Priority Data
Dec. 24, 2003 (JP) 2003-427865

(51) Int. Cl. H01P 7/10

(52) U.S. Cl. 333/219.1; 333/202

(57) ABSTRACT

A dielectric resonance element resonating in the TE01 δ mode and a protrusion portion disposed in a direction perpendicular to the bottom surface of the dielectric resonance element are integrally molded, and the side face at the outer periphery of the protrusion portion is tilted such that the area on the bottom-surface side of the dielectric resonance element is larger than the area of the lower surface of the protrusion portion. Because of such a structure, the magnetic field of the dielectric resonance element spreads to the tilted portion of the side face at the outer periphery of the protrusion portion and around the tilted portion of the side face, and the magnetic field distribution increases under the dielectric resonance element. Even if an input-output electrode is disposed at a location away from the protrusion portion, the input-output electrode is strongly coupled to the dielectric resonance element, resulting in a sufficient coupling.

### TECHNICAL FIELD

The present invention relates to a TE01 δ-mode dielectric resonator used in the microwave band and the millimeter wave band, to a filter, duplexer, and oscillator using the dielectric resonator, and to a communication device having these.

### BACKGROUND ART

In radio communication systems such as portable telephones, etc., using the microwave band or the millimeter wave band, dielectric resonators are used in filters and oscillators in the systems. Then, a TE01 δ-mode dielectric resonator is used in applications where high Q and high power resistance are required. In the TE01 δ-mode dielectric resonator, a cylindrical or polygonal dielectric resonance element is held on a support. In order to connect the resonator to an outer circuit, an input-output electrode such as a microstrip line, a metal probe, etc., is required on a substrate for mounting the resonator. Here, in order to obtain desired electric characteristics of the device, it is required to set the amount of coupling to the outer circuit, which changes by the distance between the input-output electrode and the resonator, etc., to a desired value. In order to obtain a coupling to an outer circuit in the TE01 δ-mode dielectric resonator, the following method has been proposed.

In Patent Document 1, input-output electrodes of microstrip lines are disposed so as to sandwich a dielectric support where a TE01 δ-mode dielectric resonator used in microwave band oscillators is set.

Furthermore, in Patent Document 2, in order to increase a coupling to an outer circuit, a high-frequency oscillator in which a TE01 δ-mode dielectric resonance element is disposed on a support so as to be tilted. In this way, when an input-output electrode is disposed on the side where the resonance element is downward tilted, the coupling to an outer circuit can be increased. Furthermore, since the input-output electrode can be disposed at a location away from the support, the fear that the support may be set on the input-output electrode is reduced and also the possibility that oscillation characteristics may become unstable can be decreased. Patent Document 1: Japanese Unexamined Patent Application Publication No. 5-152845 Patent Document 2: Japanese Unexamined Patent Application Publication No. 2-246403

### DISCLOSURE OF INVENTION

### PROBLEMS TO BE SOLVED BY THE INVENTION

When a dielectric resonance element is cylindrical, for example, the magnetic field of the TE01 δ-mode dielectric resonator is distributed so as to pass from the vicinity of the middle of the upper surface to the upper portion of the dielectric resonance element and pass to the lower circular surface through the outside of the edge portion of the dielectric resonance element, resulting in a radial and loop-like distribution. In the structure of Patent Document 1, the magnetic field of the dielectric resonance element does not sufficiently spread around its lower portion. Accordingly, it is required to bring the microstrip line close to the vicinity of the support in order to make the dielectric resonance element strongly coupled to the microstrip line. Thus, although a strong external coupling can be obtained, when the spacing between the support and the microstrip line is not sufficient for the accuracy needed for mounting the support to the mounting substrate, there is a fear that the support may be mounted on the microstrip line. Then, the resonator characteristics change, and as a result, there occurs a problem in that the oscillation characteristics of the oscillator become unstable.

Furthermore, in the structure of Patent Document 2, the following problem arises. First, since no strong external coupling can be obtained on the side where the resonator is tilted upward, the location for disposing the input-output electrode is limited. Furthermore, in a filter, oscillator, etc., using the TE01 δ-mode dielectric resonator, it is common to dispose the resonator inside the cavity case. However, since the magnetic field above the resonator which is tilted upward has perturbations caused by the upper surface of the cavity case, the resonance frequency varies. Furthermore, since the resonator is tilted, the height of the oscillator increases. Moreover, in the case of the TE01 δ-mode dielectric resonator, the adjustment of the resonance frequency is performed by a screw, etc., from the upper portion of the resonator. Moreover, in the structure of the present patent document, since the upper surface of the resonator is tilted, the magnetic field distribution above the resonator is not uniform, and accordingly, the adjustment of the resonance frequency becomes difficult when compared with the case where the resonator is not tilted.

As described above, in the above two patent documents, although the resonator and the input-output electrode can be strongly coupled, there occurs a problem in that the characteristics deteriorate due to the mounting accuracy and the use of the resonator is limited. Then, it is an object of the present invention to obtain a TE01 δ-mode dielectric resonator in which, even if an input-output electrode is away from the resonator, a strong coupling to an outer circuit can be obtained and resonator characteristics do not change because of mounting accuracy of the resonator, to obtain a filter, duplexer, oscillator, etc., using the resonator, and to obtain a communication device using these.

### MEANS FOR SOLVING THE PROBLEMS

In order to solve the above problem, a dielectric resonator of the present invention comprises a dielectric resonance element; and a protrusion portion disposed in a direction perpendicular to the bottom surface of the dielectric resonance element, the protrusion portion integrally molded together with the dielectric resonance element. In the dielectric resonator, the side face at the outer periphery of the protrusion portion is tilted such that the area on the bottom-surface side of the dielectric resonance element of the protrusion portion is larger than the area of the lower surface of the protrusion portion, and the electromagnetic field used in the dielectric resonance element is in the TE01 δ mode.

Because of the structure, since the magnetic field of the dielectric resonance element spreads out to the tilted portion of the side face at the outer periphery of the protrusion portion and its vicinity, the spread of the magnetic field distribution can be more increased around the lower portion of the dielectric resonance element than in the related structure. Thus, even if an input-output electrode is disposed at a location away from the protrusion portion, the dielectric resonance element can be strongly coupled to the input-output electrode. Therefore, since the protrusion portion is made not to contact with the input-output electrode, resonator characteristics do not change.

Furthermore, when the side face at the outer periphery of the protrusion portion is not tilted, a step portion substantially perpendicular to each other is formed at the boundary between the dielectric resonance element and the protrusion portion. When these dielectric resonance element and protrusion portion are integrally formed by press molding, the mold density drastically changes at the boundary and the molding cannot be stably performed. However, since the step portion has a slope at the boundary between the dielectric resonance element and the protrusion portion such that the side face at the outer boundary of the protrusion portion is tilted, the drastic change of the mold density is lessened and it becomes able to perform a stable molding. Furthermore, because of such a structure, it becomes able to use an easy and low-cost one-axis press molding.

Next, according to the present invention, when the spacing and coupling length between the protrusion portion and the input-output electrode are the same, even if the input-output electrode is disposed at any location around the protrusion portion, the same amount of coupling can be obtained and the location of disposition of the input-output electrode is not limited.

Moreover, according to the present invention, the area of the bottom surface of the dielectric resonance element is larger than the area on the bottom-surface side of the dielectric resonance element of the protrusion portion. When constructed in this way, a ring-shaped flat portion can be formed at the edge portion of the bottom surface of the dielectric resonance element. In the TE01 δ-mode dielectric resonator of the present invention, the dielectric resonance element and the protrusion portion are integrally formed by using a molding die. Sharp portions in the molding die are eliminated such that a flat portion is provide on the bottom surface of the dielectric resonance element as in the present invention, and as a result, the durability and wear resistance of the molding die are improved.

Furthermore, when a TE01 δ-mode dielectric resonator of the present invention is used in a filter or oscillator, even if a strong coupling to an outer circuit is required in order to obtain required filter or oscillator characteristics, since the change of resonator characteristics due to mounting accuracy does not occur, desired filter or oscillator characteristics can be obtained.

Furthermore, when a duplexer is produced by using a filter using a TE01 δ-mode dielectric resonator of the present invention, even if a strong coupling is required between the resonators and the input-output electrodes of the transmission-side circuit, reception-side circuit, and antenna, since the change of resonator characteristics due to mounting accuracy does not occur, desired duplexer characteristics can be obtained.

Furthermore, in a communication device using at least one of a TE01 δ-mode dielectric resonator of the present invention, a filter, duplexer, oscillator, etc., using the resonator, desired characteristics can be obtained in the same way as in the above devices. Advantages

As describe above, a dielectric resonator of the present invention comprises a dielectric resonance element; and a protrusion portion disposed in a direction perpendicular to the bottom surface of the dielectric resonance element, the protrusion portion integrally molded together with the dielectric resonance element. In the dielectric resonator, the side face at the outer periphery of the protrusion portion is tilted such that the area on the bottom-surface side of the dielectric resonance element of the protrusion portion is larger than the area of the lower surface of the protrusion portion, and the electromagnetic field used in the dielectric resonance element is in the TE01 δ mode. As a result, even if an input-output electrode is away from the protrusion portion, a strong coupling to an outer circuit can be obtained, and the change of resonator characteristics due to mounting accuracy does not occur.

### BRIEF DESCRIPTION OF THE DRAWINGS

FIG. 1 is a schematic sectional view of a TE01 δ-mode dielectric resonator according to an embodiment of the present invention.

FIG. 2 is a graph showing the relation between a distance from an arbitrary point at the outer periphery of the lower surface of the protrusion portion of the TE01 δ-mode dielectric resonator according to an embodiment of the present invention and a magnetic field strength at the distance.

FIG. 3 is a schematic sectional view of a molding die used when the TE01 δ-mode dielectric resonator according to an embodiment of the present invention is integrally molded and a TE01 δ-mode dielectric resonator.

FIG. 4 is a schematic sectional view of embodiments where, in the TE01 δ-mode dielectric resonator according to an embodiment of the present invention, the shape of the tilted side face at the outer periphery of the protrusion portion is altered.

FIG. 5 is a schematic sectional view of embodiments where a hollow or a hollow with a tilted side face is provided in the TE01 δ-mode dielectric resonator according to an embodiment of the present invention.

FIG. 6 is a schematic sectional view of an embodiment where a through hole is provided in the TE01 δ-mode dielectric resonator according to an embodiment of the present invention.

FIG. 7 is a schematic sectional view of a filter produced by using the TE01 δ-mode dielectric resonator according to an embodiment of the present invention.

FIG. 8 is a schematic sectional view of a duplexer produced by using the TE01 δ-mode dielectric resonator according to an embodiment of the present invention.

FIG. 9 is a schematic top view of an oscillator produced by using the TE01 δ-mode dielectric resonator according to an embodiment of the present invention.

FIG. 10 is a schematic circuit diagram showing a transmission-reception circuit of a communication device using a TE01 δ-mode dielectric resonator of the present invention.

FIG. 11 is a schematic sectional view of a related TE01 δ-mode dielectric resonator.

### REFERENCE NUMERALS

1, 20, 30, 40, 50, 60, 70, 80, and 110 dielectric resonators

2 dielectric resonance element

3 protrusion portion

4 diameter of the lower surface of a protrusion portion

5 diameter of the surface on the dielectric-resonance-element side of a protrusion portion

6 diameter of the bottom surface on a dielectric resonance element

7, 31, 41, and 51 tilted side faces at the outer periphery of a protrusion portion

8, 63, 73, 82, 83, and 111 input-output electrodes

9 mounting substrate

10, 62, and 74 cavity cases

11 arbitrary point at the outer periphery of the lower surface of a protrusion portion

12 magnetic field

13 tilted angle at the outer periphery of a protrusion portion

14 distance from an arbitrary point at the outer periphery of the lower surface of a protrusion portion

### BEST MODE FOR CARRYING OUT THE INVENTION

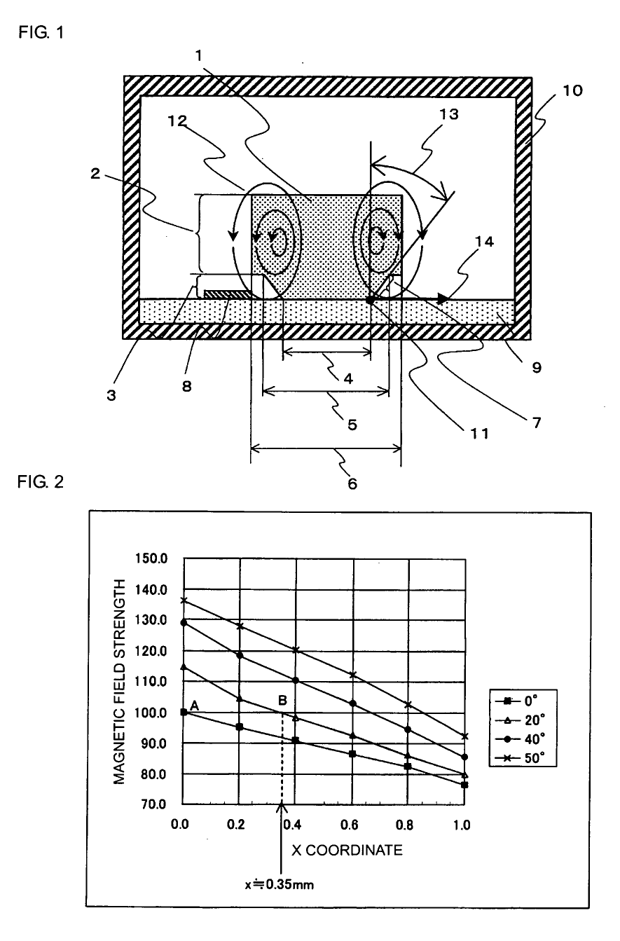

Hereinafter, a first embodiment of the present invention is described with reference to the drawings. FIG. 1 is a schematic sectional view of a TE01 δ-mode dielectric resonator 1 according to an embodiment of the present invention. In FIG. 1, a dielectric resonance element 2 is cylindrical, a protrusion portion 3 is disposed on the bottom-surface side of the dielectric resonance element 2 in an axial direction perpendicular to the bottom surface, and the section of the protrusion portion 3 is also circular. Regarding the dimensions of the TE01 δ-mode dielectric resonator 1 according to the embodiment, the diameter 6 of the bottom surface of the dielectric resonance element 2 is 5.6 mm, the thickness of the dielectric resonance element 2 is 2.5 mm, the diameter 5 of the surface on the dielectric-resonance-element side of the protrusion portion 3 is 4 mm, the diameter 4 of the lower surface of the protrusion portion 3 is 3.2 mm, and the thickness of the protrusion portion 3 is 1 mm. Thus, a tilted side face is provided at the outer periphery of the protrusion portion 3 such that the area (diameter 5) on the bottom-surface side of the dielectric resonance element 2 of the protrusion portion 3 is made larger than the area (diameter 4) of the lower surface of the protrusion portion 3. Furthermore, a ring-shaped flat portion is formed in the edge portion of the bottom surface of the dielectric resonance element 2 such that the area (diameter 6) of the bottom surface of the dielectric resonance element 2 is made larger than the area (diameter 5) of the surface on the bottom-surface side of the dielectric resonance element 2 of the protrusion portion 3. The dielectric resonator 1 is used such that the dielectric resonator 1 is glued and fixed on a mounting substrate 9 such as a glass-epoxy substrate, etc., where an input-output electrode 8 of a microstrip line using copper wiring, etc., and that the dielectric resonator 1 is covered by a cavity case 10. Moreover, the cavity case 10 is a metal case or a conductive case where a conductive material is coated on ceramics.

Furthermore, the dielectric resonance element 2 and the protrusion portion 3 are integrally formed by press molding using a dielectric material. The dielectric material of the resonator 1 used in the present embodiment is a zirconium titanate-tin titanate compound and has a dielectric constant of 38.

In the structure of the present embodiment, as shown in FIG. 1, an arbitrary point 11 at the outer periphery on the lower surface of the protrusion portion 3 of the TE01 δ-mode dielectric resonator 1 was set as a datum point, and, when a distance 14 was changed so as to be away from the arbitrary point 11, the change of the magnetic field strength was sought by performing a simulation. The result is shown in FIG. 2. Moreover, the magnetic field distribution of the TE01 δ-mode dielectric resonator 1 is as shown by reference numeral 12 in FIG. 1. Furthermore, the angles shown in FIG. 2 indicate the tilted angle 13 of the side face 7 of the protrusion portion 3 shown in FIG. 1. In this graph, the magnetic field strength at the datum point when the tilted angle 13 is zero degree, that is, when the protrusion portion 3 has no tilted side face is set as a reference, and the magnetic field strength when the distance 14 is changed is represented by a ratio to the reference value. Moreover, a schematic sectional view of a resonator of a related structure where the protrusion portion has no tilted side face is shown in FIG. 11. In the graph, the change of the magnetic field strength when the tilted angle 13 in FIG. 1 is changed is also shown.

Here, in the related structure where the tilted angle 13 is zero degree, there are cases in which it is required to dispose an input-output electrode 8 in the portion of the datum point 11 and strengthen the coupling to an input-output circuit 8 in order to obtain desired resonator characteristics. However, in such a structure, when the protrusion portion 3 is mounted on a mounting structure 9 with the present accuracy for mounting resonators, there are chances that the protrusion portion 3 is disposed on the input-output electrode 8 and resonator characteristics may be deteriorated. However, in the structure of the present invention shown in FIG. 1, when the tilted angle 13 of the protrusion portion 3 is set at 20 degrees, for example, it is understood that the same magnetic field strength as that (point A in the graph) at the datum point 11 in the related structure can be obtained at a location (point B in the graph) which is 0.35 mm away from the datum point 11. That is, the input-output electrode which is required to be disposed at the outer periphery on the lower surface of the protrusion portion in the related structure can be disposed at a location 0.35 mm away from the outer periphery on the lower surface of the protrusion portion. Because of this, when the protrusion portion 3 is mounted with the present accuracy for mounting resonators, even if the mounting location is varied, since there is a space of 0.35 mm between the protrusion portion 3 and the input-output electrode 8, there are no cases in which the protrusion portion 3 is mounted on the input-output electrode 8 and resonator characteristics are deteriorated.

Furthermore, it is understood that the larger the tilted angle 13 shown in FIG. 1 is, the farther from the datum point 11 the location where the same magnetic field strength can be obtained is. This is because the magnetic field of the dielectric resonance element 2 largely spreads to the tilted portion 7 and the area under the tilted portion 7 such that, as shown in FIG. 1, the protrusion portion 3 is made to have a tilted side face. As a result, it is understood that desired resonator characteristics can be obtained regardless of the mounting accuracy of the TE01 δ-mode dielectric resonator such that the tilted angle 13 which is not less tan 20 degrees where characteristics deterioration due to resonator mounting accuracy is not caused and less than 90 degrees where no problem is caused by the resonator structure is chosen.

Moreover, the dielectric material for the TE01 δ-mode dielectric resonator according to the present embodiment may be chosen from a group of a rare earth barium titanate compound, barium titanate compound, zinc barium tantalate compound, magnesium barium tantalate compound, rare earth aluminate-barium titanate compound, magnesium titanate-calcium titanate compound, zinc calcium niobate compound, and cobalt zinc barium niobate compound except for the material of the present embodiment in accordance with frequency bands, etc., in the specifications of resonators. Moreover, the dielectric constant of the dielectric materials at this time is in the range of 20 to 130. Furthermore, the dielectric resonance element 2 and the protrusion portion 3 are not limited to be cylindrical in shape, but also may be polygonal pole-shaped. Moreover, the input-output electrode shown in FIG. 1 is a microstrip line, but the same effect can be obtained by using a metal probe, etc., in addition to other flat lines such as a coplanar line, etc.

Furthermore, in the structure of the present invention, since the dielectric resonance element 2 has the same shape as the related product, the change of characteristics is not caused by the upper cavity case and the frequency adjustment of the dielectric resonance element 2 can be easily performed from the top.

As described above, the magnetic field distribution can be largely spread to the tilted portion at the outer periphery of the protrusion portion and the area under the tilted portion such that the side face of the protrusion portion is tilted, when compared with the related structure having no tilted portion. In this way, even if the input-output electrode is separated from the protrusion portion, a strong coupling to an outer circuit can be obtained and a TE01 δ-mode dielectric resonator in which resonator characteristics are not changed because of the affect of mounting accuracy of the dielectric resonator can be obtained.

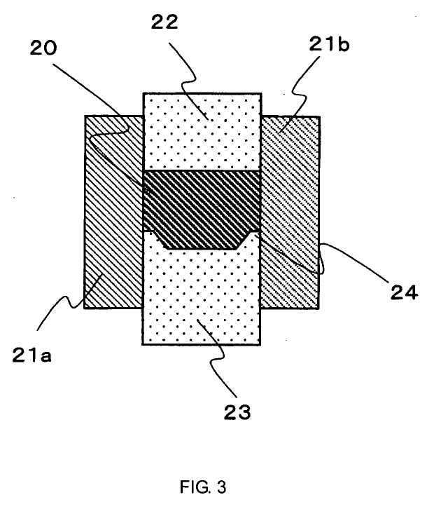

FIG. 3 is a schematic sectional view of a molding die used when the TE01 δ-mode dielectric resonator according to a first embodiment is integrally molded and of a resonator at the molding. As shown in FIG. 3, in the molding die when the TE01 δ-mode dielectric resonator is integrally molded, a die 21, a first punch 22, and a second punch 23 are required. In the TE01 δ-mode dielectric resonator of the present invention, as shown in FIG. 3, a ring-shaped flat portion 24 is provided at the edge portion of the bottom surface of the dielectric resonance element. Therefore, no portion of a weak strength such as a sharp-edged portion, etc., is required in each molding die, and the durability and wear resistance of the die can be improved.

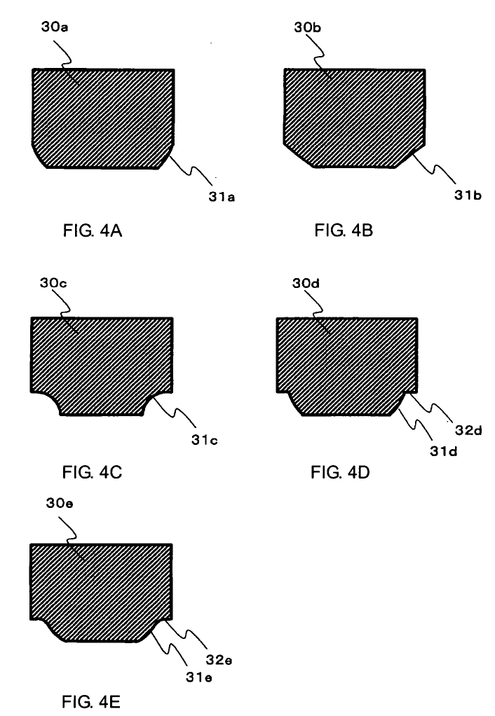

FIG. 4 is a schematic sectional view of embodiments where the tilted surfaces provided at the outer periphery of the protrusion portion of the TE01 δ-mode dielectric resonator of the first embodiment is altered in shape. Regarding the shape 31 of the tilted surface at the outer periphery of the protrusion portion, various shapes as shown in FIG. 4 can be expected in consideration of the ease of molding the dielectric resonator 30, a desired coupling to an outer circuit, the mounting accuracy of the dielectric resonator, etc. In (a) of FIG. 4, the tilted side face of the protrusion portion is outward circular arc-shaped; in (b) of FIG. 4, the tilted side face of the protrusion portion is in a straight line; and in (c) of FIG. 4, the tilted surface of the protrusion portion is inward circular arc-shaped. When, except for the tilted portion, the structure is the same and the input-output electrode is disposed at the same location from the outer periphery of the lower surface of the protrusion portion, the magnetic field strength at the input-output electrode is in the order of (a), (b), and (c) of FIG. 4, and the magnetic field strength can be adjusted by changing the shape of the tilted side face. Furthermore, in (d) of FIG. 4, a ting-shaped flat portion 32d is provided at the edge portion of the bottom surface of the dielectric resonance element. Thus, the magnetic field distribution can be spread to the area under the tapered portion and the durability and wear resistance of the molding die can be increased. Furthermore, in (e) of FIG. 4, the boundary portion between the flat portion 32e at the edge of the bottom surface of the dielectric resonance element and the protrusion portion 31e is made circular arc-shaped. Because of such a structure, since the molding die is also made circular arc-shaped, its durability and wear resistance is further improved.

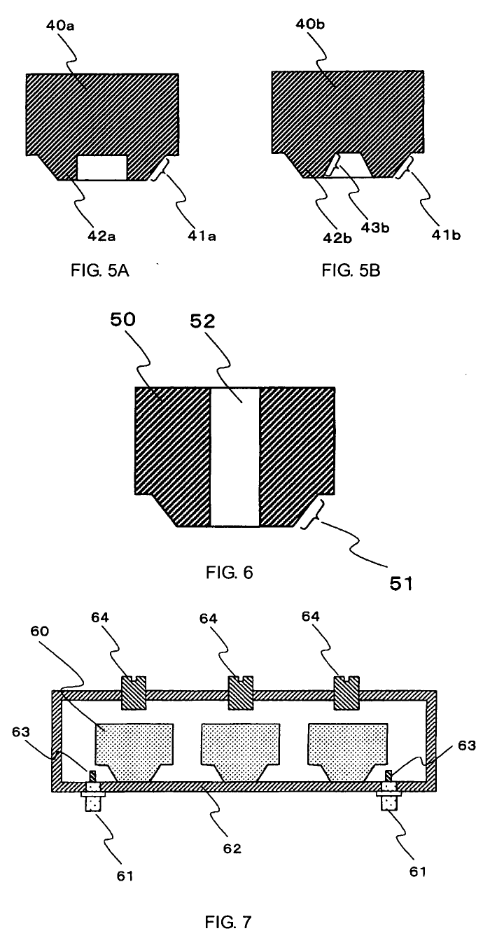

In FIG. 5, a hollow is provided in the protrusion portion of the TE01 δ-mode dielectric resonator according to the first embodiment. There are cases where a hollow is required in the protrusion portion for reasons of the manufacturing and mounting processes of dielectric resonators and for obtaining desired resonator characteristics. Even in such a case, the same effect as in the first embodiment can be obtained such that, as shown in (a) of FIG. 5, a tilted side face 41a is provided at the outer periphery of the protrusion portion 42a. Furthermore, one-axis press molding as an easy and low-cost molding method can be easily performed such that, as shown in (b) of FIG. 5, the side face of the hollow in the protrusion portion 42b has a tilted surface.

In FIG. 6, an adjustment hole 52 is provided in a resonator 50 in a direction perpendicular to the upper surface of the resonator for adjustment of the resonance frequency of the TE01 δ-mode dielectric resonator according to the first embodiment. A screw or the like is inserted into the adjustment hole 52 and the resonance frequency is adjusted in accordance with the amount of insertion. Also in such a structure, the same effect as in the first embodiment can be obtained such that the side face at the outer periphery of the protrusion portion has a tilted surface 51.

FIG. 7 is a schematic sectional view of a filter using the TE01 δ-mode dielectric resonators 60 according to the first embodiment. Three TE01 δ-mode dielectric resonators 60 are disposed in a cavity case 62 to which coaxial connectors 61 for input-output terminals are attached. At the tip of each coaxial connector 61, an input-output electrode (metal probe) 63 is provided for electromagnetic coupling to the TE01 δ-mode dielectric resonator 60. Each resonator 60 is fixed such that the lower surface of the protrusion portion is glued to the cavity case 62. Furthermore, an adjustment screw 64 for adjusting the resonance frequency is provided above each resonator 60. The cavity case 62 is made up of a metal case or a conductive case where a conductive material is coated on the surface of ceramics. Moreover, the number of resonators constituting a filter is not limited to three in order to obtain desired filter characteristics.

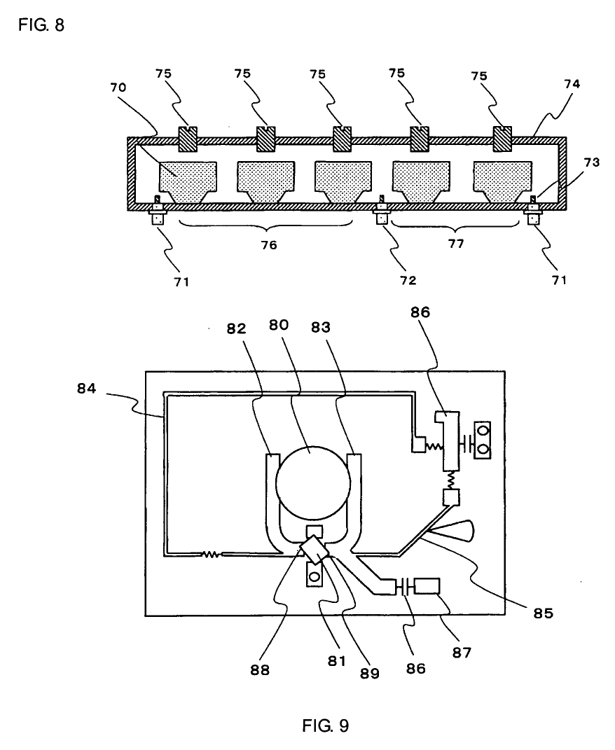

FIG. 8 is a schematic sectional view of an embodiment of a duplexer using the TE01 δ-mode dielectric resonator of the present embodiment. In FIG. 8, three TE01 δ-mode dielectric resonators 70 constituting a reception filter 76 and two TE01 δ-mode dielectric resonators 70 constituting a transmission filter 77 are disposed inside a cavity case 74. Coaxial connectors 71 in FIG. 8 are used as input-output terminals of the reception filter 76 and the transmission filter 77, and a common coaxial connector 72 is used as an antenna input-output terminal for inputting and outputting to the transmission and reception filters. At the tip of each coaxial connector, an input-output electrode (metal probe) 73 is attached for electromagnetic coupling to the resonator 70. Each resonator 70 is fixed such that the lower surface of the protrusion portion is glued to the cavity case 74 using an adhesive, etc. An adjustment screw 75 for adjusting the resonance frequency is provided above each resonator 70. The cavity case 74 is made up of a metal case or a conductive case where a conductive material is coated on the surface of ceramics. Moreover, the number of resonators constituting the filters is not limited to the above numbers in order to obtain desired filter characteristics.

FIG. 9 is a schematic top view of an embodiment of an oscillator using the TE01 δ-mode dielectric resonator of the first embodiment. A TE01 δ-mode dielectric resonator 80 is disposed so as to be coupled to one ends of a first stub 82 and a second stub 83 at a desired resonance frequency. Furthermore, the other ends of the first stub 82 and second stub 83 and collector terminal 89 of an emitter-grounded transistor 81, respectively. Moreover, a base-voltage supply wiring 84 and a collector-voltage supply wiring 85 are connected to the base terminal 88 and collector terminal 89 of an emitter-grounded transistor 81, respectively, and an oscillator output terminal 89 is also connected to the collector terminal 89 through an output load capacitor 86. Moreover, the other ends of the base-voltage supply wiring 84 and the collector-voltage supply wiring 85 are connected to a DC-voltage supply portion 86. In the oscillation circuit of the present embodiment, the dielectric resonator 80 and the first stub 82 constitute a feedback circuit and the dielectric resonator 80 and the second stub 83 constitute an oscillation-side circuit. A DC voltage is supplied to the base terminal 88 and collector terminal 89 of the transistor 81 through the base-voltage supply wiring 84 and collector-voltage supply wiring 85, respectively. An oscillation output from the collector terminal 89 of the transistor is taken out from the oscillation output terminal 87.

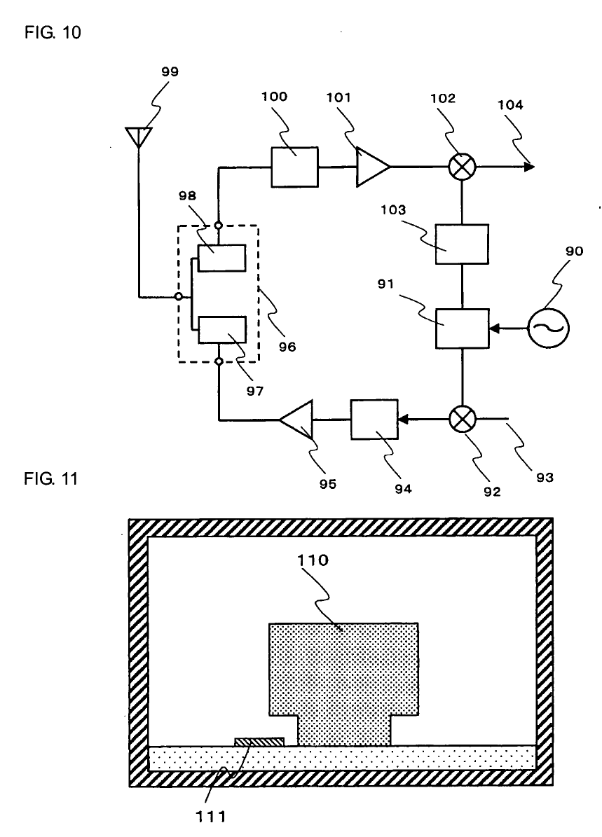

FIG. 10 shows one embodiment of a transmission-reception circuit of a communication device using the TE01 δ-mode dielectric resonator of the first embodiment. A transmission-side signal is processed in the following way. A transmission-side signal 93 is frequency-converted using a signal of a local oscillator 90 input to a mixer 92 through a frequency divider 91. Next, frequency components outside a transmission frequency band of a transmission-side signal are eliminated by a bandpass filter 94. After that, the transmission-side signal is amplified by an amplifier 95 and transmitted from an antenna 99 through a transmission-side filter 97 of a duplexer 96. Furthermore, a reception-side signal is processed in the following way. A reception-side signal received from the antenna 99 is output to a reception-side circuit through a reception-side filter 98 of the duplexer 96. Frequency components outside a reception frequency band in the signal are eliminated by a bandpass filter 100 and amplified by an amplifier 101. After that, the reception signal is frequency-converted to a frequency lower than the reception signal at a mixer 102 by using a frequency signal of the local oscillator 90 output from a bandpass filter 103, and an intermediate frequency 104 signal is output. In the circuit, the filter and duplexer shown in the above embodiments are used in the bandpass filter 94 for transmission, the bandpass filter 100 for reception, and the duplexer 96. Moreover, the TE01 δ-mode dielectric resonator of the present invention is used in the oscillator 90.

1. A dielectric resonator comprising:
a dielectric resonance element; and
a protrusion portion disposed on a bottom surface of the dielectric resonance element,
wherein a side face at an outer periphery of the protrusion portion is tilted such that an area of an upper surface of the protrusion portion adjacent the bottom surface of the dielectric resonance element is larger than an area of a lower surface of the protrusion portion, and
wherein an electromagnetic field used in the dielectric resonance element is in the TE01 δ mode.

2. The dielectric resonator as claimed in claim 1, wherein the entire side face at the outer periphery of the protrusion portion is tilted.

3. The dielectric resonator as claimed in claim 1, wherein an area of the bottom surface of the dielectric resonance element is larger than the area on the upper surface of the protrusion portion.

4. A filter comprising a plurality of dielectric resonators as claimed in claim 1.

5. A duplexer comprising two filters as claimed in claim 4.

6. An oscillator comprising a dielectric resonator as claimed in claim 1.

7. A communication device comprising a dielectric resonator as claimed in claim 1.

8. The dielectric resonator as claimed in claim 1, wherein the protrusion portion is integrally molded with the dielectric resonance element.

9. The dielectric resonator as claimed in claim 2, wherein an area of the bottom surface of the dielectric resonance element is larger than the area on the upper surface of the protrusion portion.

10. A communication device comprising a filter as claimed in claim 4.

11. A communication device comprising a duplexer as claimed in claim 5.

12. A communication device comprising an oscillator as claimed in claim 6.
